(19) United States
(12) Patent Application Publication
(10) Pub. No.: US 2007/0246895 A1
(43) Pub. Date: Oct. 25, 2007

(54) Low-torque dynamic seal

(75) Inventor: Orlando Da Mota Pavan, Sao Paulo (BR)

Correspondence Address: ARENT FOX PLLC, 1050 CONNECTICUT AVENUE, N.W., SUITE 400, WASHINGTON, DC, 20036, US

(73) Assignee: SABO INDUSTRIA E COMMERCIO LTDA

(21) Appl. No.: 11/785,956

(22) Filed: Apr. 23, 2007

(30) Foreign Application Priority Data
Apr. 24, 2006 (BR) PI 0601677-0

(51) Int. Cl. F16J 15/32

(52) U.S. Cl. 277/549

(57) ABSTRACT

A low-torque dynamic seal that seals at least one interstice defined between a moving part and a fixed part, which on a first side, opens at a location external to the fixed part, and on a second or other side, opens at a location internal to the fixed part and contains a lubricant fluid having a viscosity that is lower than conventional grease or other such lubricants. The seal includes a treatment region having adjacent surfaces of the moving and fixed parts, which define the at least one interstice. The adjacent surfaces attain superficial tensions that are substantially lower than a superficial tension of the low viscosity fluid so that the low viscosity fluid is not able to wet the adjacent surfaces. As a result, the interstice between the adjacent surfaces does not leak the low viscosity fluid therefrom.

### BACKGROUND OF THE INVENTION

1. Field of the Invention

The present invention relates to a low-torque dynamic seal.

2. Description of the Related Art

It is well known that in the automotive industry, as well as other industries, that many mechanisms include parts moving about one another that can be subject to heat and wear-generating friction, such as, for example, in an internal combustion engine. In order to overcome the heat and wea-generating friction, the mechanisms and their parts are provided with lubrication systems that use lubricating fluids to help avoid or reduce friction. Cooperating with the lubrication systems or being a part of them, dynamic seals are provided that are intended to seal interstices through which the lubricating fluid could leak to the outside of the mechanism, such as, for example, between the engine block and the crankshaft.

Conventional dynamic seals include sealing devices that essentially have rubber lips provided with free edges that form a seal against a moving part, such as a shaft; and a housing, onto which the lips are mounted. The housing is mounted on a fixed portion of the mechanism, such as the engine block. In order to ensure a good seal, the lips must exert a certain gripping force against the moving part. Consequently, the conventional dynamic seals can contribute to the reasons why the mechanism experiences certain losses in output due to friction, heat generation, and sealing wear.

Therefore, new solutions have been searched for sealing systems in mechanical constructions with moving parts subject to friction.

### SUMMARY OF THE INVENTION

It is an aspect of the present invention to provide a low-torque dynamic seal, applied in the automotive industry as well as for non-automotive applications, which is efficient and overcomes at least the aforementioned problems associated with the conventional dynamic seals.

A second aspect of the present invention is to provide a low-torque dynamic seal to the circulation of fluids with substantially low superficial tensions that are lower than greasy lubricants.

A third aspect of the present invention is to provide a low-torque dynamic seal which does not feature a rather complex structure or is difficult to manufacture compared to the conventional seals.

A fourth aspect of the present invention is to provide a seal that is relatively cost effective to manufacture.

To accomplish the foregoing aspects, a low-torque dynamic seal has been developed which considers the fact that, when a liquid is put in contact with a solid surface and the attraction (cohesion) force between their molecules is higher than the attraction (spreading) force exerted by the solid surface over the liquid, the latter does not spread but tends to agglutinate and form spherical shapes.

Thus, the low-torque dynamic seal of the present invention preferably does not provide a sealing element mounted between fixed and moving parts, which establish the interstice through which the fluid may leak. Instead, the seal comprises the treatment of the surfaces with appropriate products, such as lipofuges or hydrofuges, so that the surfaces have a substantially lower superficial tension than a superficial tension of the lubricating fluid, which will not be able to wet them, and thus, cannot leak to the outside of the mechanism.

The present invention also comprises a sealing device which uses this principle, according to which, optionally, a contact element may be provided between the moving and the fixed parts with no dynamic sealing function but with lipofuge or hydrofuge effect.

The inventive seal disclosed herein overcomes the problems associated with the conventional dynamic seal because, preferably, there is no component mounted between the fixed and the moving parts that exerts a gripping force against the moving parts as in a conventional dynamic seal, wherein there is such an element present. The present seal exerts low contact with an irrelevant amount of friction and no dynamic sealing function but for lipofuge or hydrofuge effect purposes. Thus, the inventive seal does not produce any output loss, friction, heat generation or wear in the mechanism which may affect it and the seal.

The present seal, according to the aspects of the invention, provides superficial tension on the moving and fixed parts of the mechanism, appropriate to seal lubricant fluids currently used throughout the automotive industry and non-automotive applications whose viscosities are substantially lower than greasy lubricants.

Another advantage of the present invention is the fact that the construction and manufacturing of the seal are not complex to a level that would make it unsatisfactory for the application.

The low-torque dynamic seal features still another functional advantage as it may be used bi-directionally, that is, clockwise and anticlockwise.

Another functional advantage of bidirectional sealing is how easy it is to manufacture parts for applications at low temperatures. Many applications require flexible materials at low temperatures (−40° C. or lower), as the moving systems vibrate, and the sealing elements in contact with these moving parts need to be flexible enough to follow the movements of the moving parts. Non-flexible materials at low temperatures become rigid and breakable working under these conditions which causes part performance failure. Also, materials chemically resistant to fluids and flexible at low temperatures are very expensive.

The low-torque seal herein proposed overcomes such limitations at low temperatures as it allows sealing without contact with the moving parts, making it possible to use less resistant materials which are cheaper and at low temperatures, while also ensuring efficient part performance.

Another advantage is that the present sealing cost is more appropriate to the application compared to the usual solutions.

### BRIEF DESCRIPTION OF THE DRAWINGS

FIG. 1 is a schematic diagram illustrating a mechanical structure to which a low-torque dynamic seal is applied according to a first embodiment of the present invention; and

FIGS. 2 to 4 are schematic diagrams illustrating alternate embodiments of the seal according to the present invention.

### DETAILED DESCRIPTION OF THE PREFERRED EMBODIMENTS

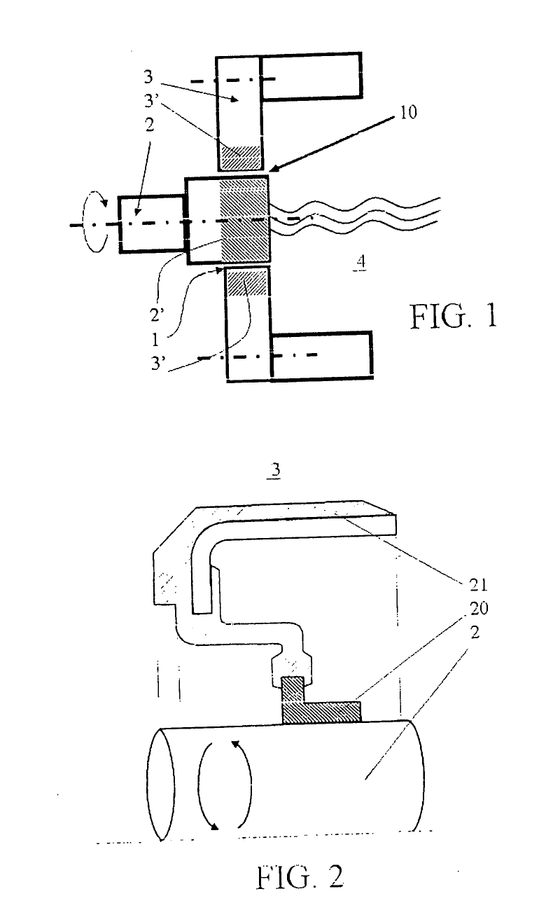

Referring to FIG. 1, the low-torque dynamic seal according to the present invention is intended to seal at least one interstice 1 defined between a moving part 2, such as, for example, a crankshaft, and a fixed part 3, such as, for example, an internal combustion engine block, which on a first side, opens at a location external to the fixed part 3, and on a second or other side, opens at a location internal to the fixed part 3 and contains a lubricant fluid 4 having a viscosity that is lower than conventional grease or other such greasy lubricants.

Thus, the seal (FIG. 1) of the present invention includes a treatment region 10 that includes adjacent surfaces 2′, 3′ of the moving part 2 and the fixed part 3, respectively, which define the at least one interstice 1. The adjacent surfaces 2′, 3′ attain superficial tensions that are substantially lower than a superficial tension of the low viscosity fluid 4. The superficial tension of the adjacent surfaces 2′, 3′ is selected so that the low viscosity fluid 4 is not able to wet the adjacent surfaces 2′, 3′, such as, for example, a superficial tension of 50 dynes/cm. As a result, the interstice 1 between the adjacent surfaces 2′, 3′ will not leak the low viscosity fluid therefrom.

The treatment region 10 is formed by using a lipofuge or a hydrofuge product that is selected from a group including fluoropolymers applied to the adjacent surfaces 2′, 3′, fluorochemicals applied to the adjacent surfaces 2′, 3′, films deposited onto the adjacent surfaces 2′, 3′ using a plasma depositing process, use of nanotechnologies, use of a laser, and/or the like.

For purposes of the present invention, lipofuge products are defined as those which repel viscous liquids, such as a grease-type lubricant, having a viscosity that is lower than a conventional grease or grease-type lubricant. Similarly, for purposes of the present invention, hydrofuge products are defined as those which repel water based liquids, such as water, liquids mixed with water, aqueous solutions, and even water mixed with solutions having solid particles dispersed therein.

The lipofuge and hydrofuge products are obtained by using lipofuge or hydrofuge materials, or materials having such lipofuge or hydrofuge characteristics but are chemically treated to have their surfaces changed in order to attain such characteristics, or receive a film or cover of material with such characteristics.

It should be noted that it is within the scope of the present invention to alter the aforementioned materials, dimensions, constructive details and/or embodiment without departing from the scope and spirit thereof.

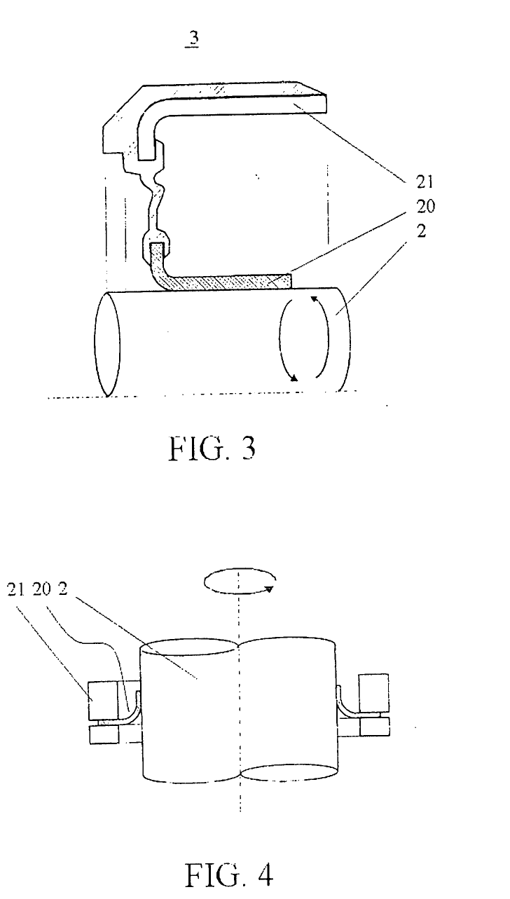

As such, in the alternate embodiments of the present invention illustrated in FIGS. 2 to 4, optionally, the system provides a device (FIGS. 2 to 4) with minimum or no contact between the adjacent surfaces 2′, 3′ of the moving part 2 and the fixed part 3 which define the interstice 1 (FIG. 1). The device of the alternate embodiments basically includes one of the following: a flexible element that is made from a lipofuge material; a flexible element having a surface treated to exhibit lipofuge characteristics; a flexible element that is made from a hydrofuge material; and a flexible element having a surface treated to exhibit hydrofuge characteristics. The flexible element manufactured or treated in any one of the above described manners, preferably is contact with the moving part 2, but it is also within the scope of the present invention for the flexible element not to remain in contact with the moving part 2 such that no dynamic seal is provided. Moreover, the flexible element that is either made from or treated with one of a lipofuge material or a hydrofuge material can be directly or indirectly mounted by a supporting element 21, which itself is mounted on the fixed part 3 (FIGS. 2-3).

The present invention may be embodied in other specific forms without departing from the spirit or essential characteristics thereof. The presently disclosed embodiments are therefore to be considered in all respects as illustrative and not restrictive, the scope of the invention being indicated by the appended claims, rather than the foregoing description, and all changes which come within the meaning and range of equivalency of the claims are, therefore, to be embraced therein.

What is claimed is:

1. A low-torque dynamic seal that seals an interstice defined between adjacent surfaces of a moving part and a fixed part of a mechanism, wherein a first side of the fixed part opens at a location external relative to the mechanism, and a second side of the fixed part, which opens at a location internal to the mechanism and contains therein a lubricant having a viscosity that is lower than a grease, wherein the interstice is free of any blockage, wherein the adjacent surfaces are treated with a lipofuge product, and wherein the adjacent surfaces have a superficial tension that is lower than a superficial tension of the lubricant that prevents the lubricant from leaking through the interstice.

2. The seal according to claim 1, wherein the interstice comprises a flexible element that is either manufactured from a lipofuge material or is treated with a lipofuge material and has a superficial tension that is lower than the superficial tension of the lubricant.

3. The seal according to claim 1, wherein the superficial treatment of the adjacent surfaces is less than 50 dynes/cm.

4. The seal according to claim 1, wherein the lipofuge product is one of fluoropolymers, fluorochemicals applied to the adjacent surfaces, and films deposited by plasma processes onto the adjacent surfaces.

5. The seal according to claim 1, wherein the lipofuge product is incorporated onto the adjacent surfaces to a depth of 0.5 mm and a width of 15 mm.

6. The seal according to claim 1, further comprising:
a flexible element made of a lipofuge material or treated with a lipofuge material, wherein the flexible element is disposed within the interstice and contacts the moving part; and
a supporting element on which the flexible element is mounted,
wherein the supporting element is mounted on the fixed part.

7. The seal according to claim 6, wherein the flexible element is 15 mm wide and connected to the supporting element by a rubber flexible material element.

8. A low-torque dynamic seal that seals an interstice defined between adjacent surfaces of a moving part and a fixed part of a mechanism, wherein a first side of the fixed part opens at a location external relative to the mechanism, and a second side of the fixed part, which opens at a location internal to the mechanism and contains therein a lubricant having a viscosity that is lower than a grease, wherein the interstice is free of any blockage, wherein the adjacent surfaces are treated with a hydrofuge product, and wherein the adjacent surfaces have a superficial tension that is lower than a superficial tension of the lubricant that prevents the lubricant from leaking through the interstice.

9. The seal according to claim 8, wherein the interstice comprises a flexible element that is either manufactured from a hydrofuge material or is treated with a hydrofuge material and has a superficial tension that is lower than the superficial tension of the lubricant.

10. The seal according to claim 8, wherein the superficial treatment of the adjacent surfaces is less than 50 dynes/cm.

11. The seal according to claim 8, wherein the hydrofuge product is one of fluoropolymers, fluorochemicals applied to the adjacent surfaces, and films deposited by plasma processes onto the adjacent surfaces.

12. The seal according to claim 8, wherein the hydrofuge product is incorporated onto the adjacent surfaces to a depth of 0.5 mm and a width of 15 mm.

13. The seal according to claim 8, further comprising:
a flexible element made of a hydrofuge material or treated with a hydrofuge material, wherein the flexible element is disposed within the interstice and contacts the moving part; and
a supporting element on which the flexible element is mounted,
wherein the supporting element is mounted on the fixed part.

14. The seal according to claim 13, wherein the flexible element is 15 mm wide and connected to the supporting element by a rubber flexible material element.
